(19) United States
(12) Patent Application Publication
(10) Pub. No.: US 2005/0288937 A1
(43) Pub. Date: Dec. 29, 2005

(54) System and method for monitoring and tracking individuals

(76) Inventor: Vincent L. Verdiramo, Martinsville, NJ (US)

Correspondence Address: HOFFMANN & BARON, LLP, 6900 JERICHO TURNPIKE, SYOSSET, NY, 11791, US

(21) Appl. No.: 10/508,641

(22) PCT Filed: Mar. 18, 2003
(86) PCT No.: PCT/US03/08334

§ 371 Date: May 9, 2005

Related U.S. Application Data
(60) Provisional application No. 60/364,592, filed on Mar. 18, 2002.

(51) Int. Cl. G06F 17/60

(52) U.S. Cl. 705/1; 705/10

(57) ABSTRACT

The present invention provides a system and method for monitoring and tracking individuals in a facility. The method includes registering the individuals immediately upon entrance to the facility and assigning a tag to each individual. The tag includes the data corresponding to the individuals and any objects related to the individuals. The method further includes storing the data and obtaining information from the tag as the individual moves within the facility. Finally, the individuals are tracked and monitored via the information obtained from the assigned tag.

### CROSS-REFERENCE TO RELATED APPLICATION

This application claims priority to U.S. Provisional Application No. 60/364,592 filed on Mar. 18, 2002.

### FIELD OF THE INVENTION

The invention relates to a field of safety and security, and more particularly to a system and method for electronically identifying, monitoring and tracking individuals in and through various public and private facilities.

### BACKGROUND OF THE INVENTION

Recently, there has been a growing concern for the safety and security of the lives of people who use or visit major facilities around the world. Presently, people move freely throughout the majority of facilities such as airports, train stations, tourist attractions, skyscrapers, etc. without any universal system of tracking their whereabouts. Several methods and systems have been proposed in the past to not only track these individuals, but also monitor them.

One such method is shown in U.S. Pat. No. 6,108,636 to Yap et al. In this patent there is shown the use of an improved security identification cards, such as drivers' license, passports, visas, etc. that identifies a person, objects such as luggage, and travel information. The system does identify authorization in certain areas as well as other suitable security information. Besides, regular identification data such as a person's name, age, height, weight, photo and the like, the biometric data of the person such as finger print, voice print, face scan, and retina scan, will also be stored in the card and matched with, for instance a luggage identification document. So, the person in the airport or other facilities can repeatedly pass through existing security checkpoints and the biometric data can be crosschecked. This is especially beneficial at the time of receiving boarding passes, or entering the security checkpoint or even before boarding the plane in airport situations.

U.S. Pat. No. 5,656,570 to Lepkofker discloses a system for determining the location of an individual by a belt pod device worn by an individual. A user wears both a belt pod and a wristwatch. The belt pod receives medical, location and other information selected by and inputted by the user via the wristwatch and further transmits information to a central monitoring unit. The belt pod device receives any alerts and queries from the central unit and passes it to the wristwatch that is received by the user. The user can send signals by the press of a button on the wristwatch in case of any emergency (such as “accident”, “medical”, “kidnapping”), and that signal will be forwarded to the belt pod device that will initiate an alarm signal to the central monitoring unit.

A further method of electronically identifying and monitoring individuals is shown in U.S. Pat. No. 4,952,928 to Caroll et al. In this patent, a tag or transmitting unit is carried or worn by an individual. The system not only monitors and identifies the location of the individual, but also selectively monitors other prescribed information about the individual, such as whether the individual is complying with mandated restrictions or activities that might be ordered by the court of law, a physician, etc. Other activities that might be monitored are the occurrence or non-occurrence of physical exercise or personal hygiene, pulse rate, heart rate, etc. is monitored, appropriate sleeping or resting state, episodes of violence, or the like. Certain physical activities are monitored by a video camera in place within the vicinity of the individual.

None of the prior technology provides an adequate system for serving the multiplicity of security needed in identifying, monitoring, and tracking of individuals in public and private facilities. Therefore, a need exists for an enhanced safety and security system.

### SUMMARY OF THE INVENTION

The present invetion provides a method and a system for tracking and monitoring individuals in a facility. The system including an input device for registering the individuals immediately upon entrance to the facility wherein the registering includes obtaining data of the individuals and objects related to the individuals and assigning a tag to each of the individuals, wherein the tag is encoded with the data corresponding to the registering of the individual, a central processor for receiving and storing the data related to the assigned tag, electronic computing device linked bidirectionally to the central processor, wherein the electronic computing device obtains information from the tag when the tag is within a predetermined distance from the electronic computing device and forwards the information to the central processor, and a security workstation for receiving the data and information regarding the assigned tag from the central processor and further tracking and monitoring the individuals via the assigned tags.

### BRIEF DESCRIPTION OF THE DRAWINGS

FIG. 1 is a block diagram illustrating a security system according to the embodiment of the present invention.

FIG. 2 is an enlarged view of the gate according to the preferred embodiment of the present invention.

### DETAILED DESCRIPTION OF THE INVENTION

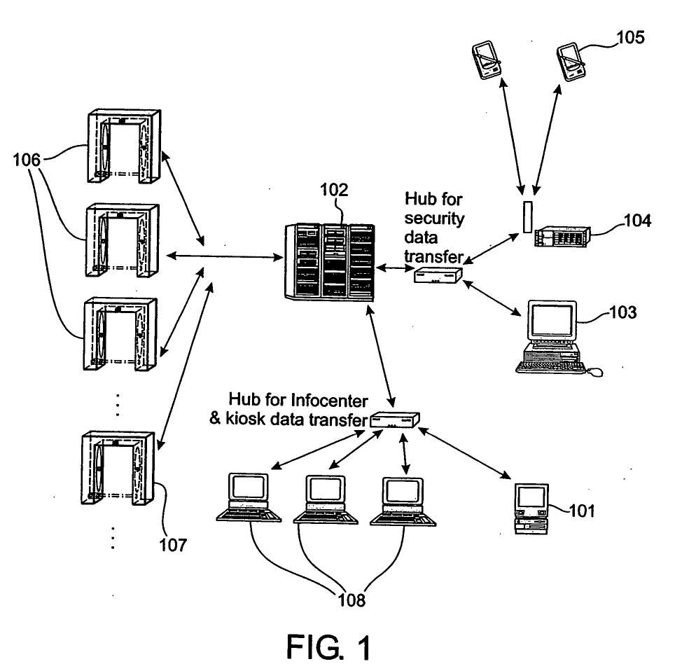

With reference to FIG. 1 there is shown an illustrative diagram of a security system 100 describing the operation of identifying, locating and monitoring individuals according to an embodiment of the present invention. The drawing illustrates a kiosk 101, a simple computer system, which is the first system element that the person encounters as he/she enters a facility. Such facilities may include airports, train stations, skyscrapers, tourist attractions, sport stadiums, or any other facility, which attracts a big crowd or constant traffic and therefore requires a safe and secure environment. The facility used in the example of the present invention is an airport, however, the present invention is not limited to airports only and can apply to any other facility requiring the security system as disclosed in the present invention. As soon as a person(s) with or without luggage arrives at the airport, he/she is directed to kiosk 101. If the person is a passenger traveling on an airplane, kiosk 101 registers the passenger. Kiosk 101 scans the plane ticket, cross-references the itinerary, fingerprint, any identification cards, takes a picture of the passenger, measures the luggage weight, etc., then sends all this data to the mainframe computer (server) 102. Kiosk 101 will encode an electronic tag of the passenger based on his/her specific, preferred data. If the person entering the airport is a visitor or vendor, kiosk 101 will encode a visitor an electronic tag of the visitor based specifically on his/her data with some additional information such as the purpose of the visit, whether visitor is with the passenger or coming to pick up a passenger in the airport, etc. If the person is an airport employee, kiosk 101 will encode the employee's tag accordingly with his/her own specific data with some additional information such as the employee's assigned areas to perform their job function, etc. The employee is assigned a tag immediately upon check-in for work. As the person, leaves kiosk 101, the specific data of that person is sent by kiosk 101 to the mainframe 102, thereby reducing the registration time. Kiosk 101 assigns an electronic tag to each person and, if any, to their corresponding luggage and carry-on items etc. Preferably, an attendant at kiosk 101 may affix the electronic tag on baggage and place them on the conveyor to be screened. The passenger may be tagged possibly by an automatic system such as placing his/her hand in an appropriate device that clips the tag to the person's wrist. Every person or object entering the airport gets assigned with the electronic tag. Each electronic tag is uniquely encoded with the recipient's personal data. If the recipient is a traveler, his or her personal data is cross-linked with all their bags and other travelers in that person's party. In the case of employees or vendors, their personal data will be linked with their assigned areas and, if recipients are visitors, their personal data will be linked to purpose of visit, etc.

The electronic tag, which may be referred to as a tag device, is a wristwatch-sized electronic monitoring device attached to every object or person upon entering the airport facility. It is the watch-like tag device that will contain electronics that can send and receive a signal in a specific frequency. The tag device will preferably have a band which fits a person's wrist, a LED window on the outward face and a biometric sensor preferably on the bottom that directly contacts the skin of the wrist of the wearer. The tag device communicates and provides information at the In-process gates 106 (I-gates) of FIG. 1, as will be explained more in detail below.

The tag device is a hybrid device mainly comprised of two parts, a passive part and an active part. In normal operation, the tag device utilizes the passive mode, which is a commonly used secure, passive, powerless RFID (Radio Frequency Identification) chip having a fixed unique serial identification number that can be read by a suitable reader. The RFID chip may be any of a variety of well-known silicon chips, which are capable of receiving, storing and transferring data using known contact less communication protocols such as radio frequency transmission and reception communication protocols. Moreover, in passive mode, the tag device sends digital radio signals on a specified frequency when it crosses the I-gate 106 of FIG. 1 as will be described later. Active part of the tag device includes circuits of a radio transmitter with a battery built in which transmits data stored in memory to alert the security staff. In the active mode, the tag device sends a start signal at the I-gate 106 of FIG. 1, which activates the transmitter. The transmitter remains on until the security staff gets in touch with the wearer. The tag device has a built-in-antenna (not shown) that communicates with the reader. The antenna is a multi turn coil arrangement that is laid down on the printed circuit board, inside the body of the tag device. Alternatively, the antenna may be placed inside the wristband for extended distance. The antenna design must be derived from the RFID device and its selected operating frequency. The antenna receives electrical signals preferably in the form of radio waves from the I-gates 106 to be described later.

The tag device is normally in a sleep mode in which the electronic components are not powered up. After receiving a signal and being powered up, the tag device is ready to receive and transmit data. Thus, it is not necessary for the tag device to have an internal power source. Instead, the power required for operating the electronic components embedded on the tag device is received from several systems such as I-gates 106, end-gates 107, info-centers 108 of FIG. 1 to be described later.

Since the tag device with a single chip does not require any power source, it receives electrical energy from the interrogating antenna. For example, a built in the I-gate 106 of FIG. 1, stores this energy in the onboard capacitor and responds to the interrogation with its unique serial number transmitted back to the reader. During interrogation, i.e. at close proximity of the I-gate, 106 of FIG. 1, the tag device is read. In case a security breach is detected, the signal from the I-gate 106 activates the tag device, which turns on the tracer. The tag device now continuously emits a high frequency tracer signal, preferably via its built-in antenna to be easily located by security personnel. In this active mode the tag device consumes electrical energy from the onboard battery. The tracer signal frequency and code may be selected to match suitable tracer readers and the tag battery capacity. The wearer need not know that his/her tag device is active.

Alternatively, the tag device's built-in “incapacitor” may be activated upon command signal from the I-gate 106 or security personnel in case of a serious break in security protocol, thereby preventing unauthorized personnel from entering secured areas or non-authorized areas. Airtag's incapacitating device may preferably be any of the acoustic, radio wave or high voltage devices.

In one embodiment of the present invention, the built-in biometric sensor of the tag device may monitor certain bodily functions, such as body temperature, heart rate, respiration of the wearer, blood pressure or skin resistance, and it may store measured data and report it to the I-gate 106 upon interrogation.

The LED window or display on the tag device allows the wearer specific data to be displayed. Additionally, the display allows for reverse messaging to alert the wearer to changes in itinerary, delays, gate reassignments, etc. preferably all in the wearer's native language.

The tag device preferably has a locking mechanism. After it is attached to the wearer, it is fixed, and cannot be easily removed. Only a special tool may remove it. The tag device's electronic circuitry may monitor continuity around the wrist. In case the loop is broken, it is reported back to the chip and the tag device is activated, sending a signal to the mainframe 102 and then to security 103. Preferably, after process is completed, and the wearer is leaving the facility at the end-gate 107 of FIG. 1, the band is initially left on the passenger, and only the electronic part will be removed. Further, band may be removed by using UV light control materials. The electronic part of the tag device is reusable with the previous wearer's specific data readily purged prior to its re-encoding with a new wearer's specific data.

It is desired that the tag device be simple, reliable and consume very little power. It is expected that the tag device should operate without any malfunction for 3-5 years at continuous, 24-hours use. The tag device preferably will not have any mechanical (moving) parts. The reliable reading distance of the tag device should desirably be at least 10 feet. In any configuration, the tag device is a single chip custom electronic device. All functions are incorporated into the chip. Its construction, operation and specification are kept confidential. It cannot be disassembled without destroying it. Its internal battery can preferably be recharged without opening it.

Now referring back to the operation of the security system shown in FIG. 1, the mainframe 102 is a custom built server computer configured for high performance database handling and communication. The mainframe 102 has a high capacity database installed to store necessary passenger information. The mainframe 102 preferably may be connected to other data source systems like airport ticketing and flight information systems. The mainframe 102 is interfaced to clients via hubs and switches. A server program runs in the mainframe 102 which controls all data transfer between kiosk 101, security workstations 103, in-process gates (I-gates) 106, end-gates 107 and info-centers 108. The mainframe 102 forwards the passenger data received from kiosk 101, related to the assigned tags to the security workstation 103.

Preferably, desktop computers are placed at the security workstation 103. The software, which is installed on this hardware enables high level data handling on database placed on a mainframe like SQL queries, data modification etc. This client software is connected to the host and provides data to security staff to increase their work efficiency. The operator will be alerted if the tag device is out of its assigned area, and the software provides solutions like begin to locate the person, or activate the alert signal in the tag device or transfer data to wireless server 104. The wireless server 104 receives information and commands from the security workstation 103, gets data from the mainframe 102 and forwards the result to portable devices, such as handhelds 105 via radio frequency. The RF interface preferably has a high-speed capability in order to communicate with multiple slaves simultaneously. The handhelds 105 preferably can be any type of portable device, such as handheld computer or a wireless data terminal (PDA) upgraded with radio data communicator like Bluetooth or any other well-known wireless network device. So, when the tag device is activated, possibly when the user crossed unauthorized I-gate 106, all information of the wearer is transferred via handhelds 105 to security officers in charge of that area to help locate the person. The handheld devices 105 are permanently logged in the network and the operator at the security workstation 103 is informed when the communication is lost between the handheld 105 and the wireless server 104.

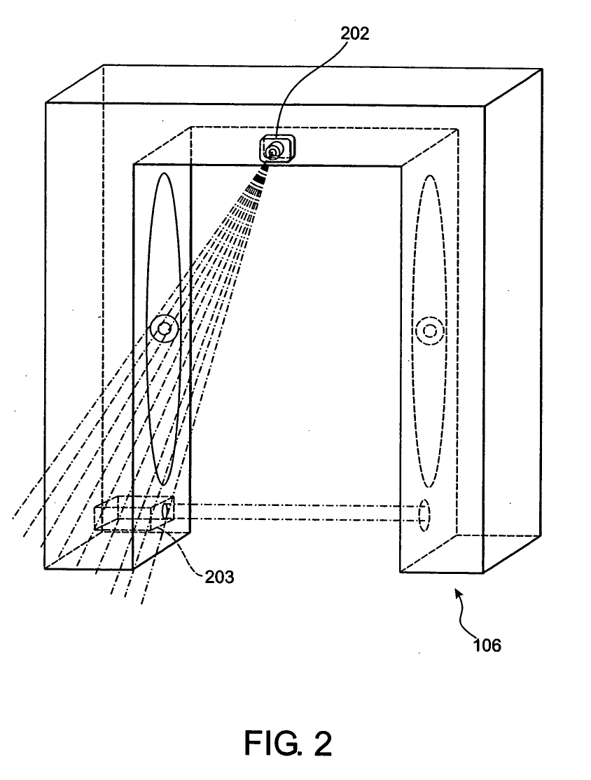

I-gates 106 as shown in FIG. 1 are installed throughout the airport as well as on the airplane. Some of the preferred areas where the I-gates may be installed in the airport are hallways, movable walkways, gate entries, security checkpoints, restrooms, stores, etc. I-gates 106 can preferably be built into facilities unnoticed. An enlarged picture of an I-gate 106 is shown in FIG. 2. I-gate 106 is a highly sophisticated electronic computing device. It is a stationary gate, which is connected to a high speed, dedicated and secured network. All I-gates 106 are linked to a high-speed mainframe computer 102, as shown in FIG. 1. There is a bi-directional communication between the I-gates 106 and the mainframe 102. The I-gate 106 incorporates a dual antenna and reader for interrogating incoming tag device. It also has an onboard processor for data handling and communication and encrypting. The I-gate 106 also comprises a video or fast hi-resolution still digital camera, 202, as shown in FIG. 2, to take the picture of the passenger with the tag device. Furthermore, it also has an infrared motion detector 203, as shown in FIG. 2 to not only sense and identify tag device, but also to obtain detailed information about through-traffic in and around the gate. So, when a tagged object approaches an I-gate 106, the motion detector 203 sends signal to the camera 202 which in turn begins to operate and takes the video (motion or still) images and records within. When the tag device crosses the I-gate 106, the antenna reads tag D number from the tag device. The I-gate 106 sends an information package, including tag ID number, video image data to the mainframe server 102. The mainframe server 102 verifies the ID number with previously stored tag ID numbers, analyses the entry in the database and makes an immediate decision to allow the passenger free passage through the I-gate 106. I-gate 106 may preferably have a high capacity database of previously stored tag ID numbers and therefore verifies the tags locally. When the I-gate 106 receives an “OK” response from the mainframe 102, it takes no action. However, in case the tag device is not allowed to pass that I-gate 106, the I-gate 106 receives a breach response from the mainframe 102. Then, the I-gate 106 immediately activates the tracer inside the tag device and after verifying that the tracer is on, I-gate 106 reports the status back to the mainframe 102. From that point, the object is easily identified by security since the tracer continuously emits high frequency radio signals, detectable by handheld reader 105. In case of a serious breach, the I-gate 106 may activate the built-in incapacitator to prevent unauthorized personnel from entering and/or proceeding through secured areas.

In one embodiment, if the tag device is removed or the monitored body function data is interrupted, the tag device reports to the nearest I-gate 106, which in turn, alerts the mainframe 102 and activates the tracer inside the tag device and the wearer is identified and located. Again, it is important to note that the wearer need not know that his or her tag is activated. Additionally, the I-gate 106 has the capability of reading multiple tag devices simultaneously, preferably at the minimum speed of 20 tags per second. Moreover, the I-gate identifies the moving direction of the tag devices.

Additionally, in another embodiment of the present invention, the I-gate 106 may display customized and related information received from the mainframe 102 on its optional information display. Alternatively, it may present preloaded information related to selected and identified tag device, such as flight information, gate number, etc.

End-gates 107 are installed at the exit points of the facility. Just prior to exiting the facility, the wearers tagged with the tag device and their tagged luggage with tag device are encountered by the end-gates 107. The end-gates 107 are where the tag device is taken off from the wearer and the luggage. Preferably, the band is initially left on the wearer and on the luggage and only the electronic part of the tag device is removed. The bands are then removed using UV light control materials. No object can leave the facility tagged. If the person attempts to leave the facility at the end-gate 107 without having the tag device removed, the end-gate 107 functions similarly as the I-gate 106 by activating the built-in incapacitator to prevent the person tagged with the tag device from leaving the facility.

Info-centers 108 are preferably located throughout the airport facility. When a tagged object is in the front of the info-center 108, a windows-like program provides helpful information specific to that passenger about his/her flight, gate info, delays, etc. It may also provide other general services such as advertisements, bank transaction, exchange, hotel-car rentals, etc.

While the invention has been described in relation to the preferred embodiments with several examples, it will be understood by those skilled in the art that various changes may be made without deviating from the spirit and scope of the invention as defined in the appended claims.

1. A system for tracking and monitoring individuals in a facility, comprising:
an input device for registering the individuals immediately upon entrance to the facility wherein said registering includes obtaining data of the individuals and objects related to said individuals and assigning a tag to each of the individuals, wherein said tag is encoded with the data corresponding to the registering of the individual;
a central processor for receiving and storing said data related to the assigned tag;
electronic computing device linked bidirectionally to said central processor, wherein said electronic computing device obtains information from the tag when the tag is within a predetermined distance from the electronic computing device and forwards the information to the central processor; and
a security workstation for receiving said data and information regarding the assigned tag from the central processor and further tracking and monitoring the individuals via the assigned tags.

2. The system of claim 1 wherein said input device includes a kiosk at which the data of the individual is registered and encoded.

3. The system of claim 1, wherein said central processor includes a mainframe.

4. The system of claim 1, wherein said electronic computing device includes an I-gate having an electronic reader for reading the tag device within said predetermined distance.

5. The system of claim 1, wherein said system security workstation provides a signal regarding the tracked individual.

6. A method for tracking and monitoring individuals through a facility comprising:
registering the individuals immediately upon entrance to the facility, wherein said registering includes obtaining data of the individuals and objects related to said individuals;
assigning a tag to each of the individuals, wherein said tag is encoded with the data corresponding to the registering of the individual;
receiving and storing the data related to the assigned tag;
obtaining information from the tag during movement of a predetermined distance by the individual; and
tracking and monitoring the individuals via the assigned tag.
